(19) United States
(12) Patent Application Publication
(10) Pub. No.: US 2017/0229074 A1
(43) Pub. Date: Aug. 10, 2017

(54) DISPLAY DEVICE

(71) Applicant: Japan Display Inc., Tokyo (JP)

(72) Inventor: Toshifumi TAKEHARA, Tokyo (JP)

(21) Appl. No.: 15/407,798

(22) Filed: Jan. 17, 2017

(30) Foreign Application Priority Data
Feb. 5, 2016 (JP) 2016-020678

(51) Int. Cl. G09G 3/34

(52) U.S. Cl. CPC G09G 3/3406; G09G 2320/0646; G09G 2310/08

(57) ABSTRACT

A liquid crystal display device including a liquid crystal display panel, a backlight, a video signal processing circuit, and a backlight control unit is further provided with a circuit for transmitting or receiving optical data, and a communication data conversion circuit for converting the optical data into an effective value allowed to be superimposed on an input to the backlight. The effective value is input to the backlight control unit so as to allow variation of luminance of the backlight.

### CLAIM OF PRIORITY

The present application claims priority from Japanese Patent Application JP 2016-20678 filed on Feb. 5, 2016, the content of which is hereby incorporated by reference into this application.

### BACKGROUND OF THE INVENTION

(1) Field of the Invention

The present invention relates to a display device. More specifically, the present invention relates to a liquid crystal display device which enables optical communication with the outside.

(2) Description of the Related Art

The known optical information communication technology requires both transmitter and receiver which are employed exclusively for the optical communication signal. On the ground of the recent trend of increasing employment of the LED for the backlight of the liquid crystal display device, the technology enabling the optical communication has been developed by superimposing the optical communication signal on the light output from the LED. Meanwhile, the optical sensor disposed on the display region also allows reception of the information from the outside through optical communication.

Japanese Unexamined Patent Application Publication No. 2004-328632 discloses transmission of the optical signal from the liquid crystal display device using the backlight. Japanese Unexamined Patent Application Publication No. 2006-94014 discloses the use of the display region as the receiver by superimposing the signal for optical communication on illumination. Japanese Unexamined Patent Application Publication No. 2011-118195 discloses the local dimming technology for irradiating only a part of the display region, which requires to be illuminated with the light emitted from the backlight of the liquid crystal display device.

### SUMMARY OF THE INVENTION

The frequency band of the light for optical communication is significantly higher than that of the signal input to the LED employed for the backlight of the liquid crystal display device. Therefore, such use has been regarded as being irrelevant to luminance of the backlight irradiated to the display region.

It has been clarified that quality of the image derived from the optical communication is likely to be deteriorated compared with that of the image derived from the communication except the optical communication. The inventor has found out that the deterioration is caused by superposition of the effective value of the signal for the optical communication on the input to the LED, which may vary the backlight luminance.

It is an object of the present invention to provide a liquid crystal display device adapted to the optical communication, which is configured to make the display image quality derived from the optical communication equivalent to the one derived from the other communication except the optical communication. Besides the liquid crystal display device, this applies to both the display device that employs the backlight, and the display device that does not employ the backlight.

The problems may be solved by the present invention based on those aspects as described below.

(1) The liquid crystal display device having a liquid crystal display panel, a backlight, a video signal processing circuit, and a backlight control unit is provided with a circuit for transmitting or receiving optical data, and a communication data conversion circuit for converting the optical data into an effective value allowed to be superimposed on an input to the backlight. The effective value is input to the backlight control unit so as to allow variation in a luminance of the backlight.
(2) The liquid crystal display device having a liquid crystal display panel, a backlight, a video signal processing circuit, and a backlight control unit is provided with a circuit for transmitting or receiving optical data, and a communication data conversion circuit for inputting the optical data to the video signal processing circuit for conversion into an effective value allowed to vary a screen luminance. The effective value is input to the video signal processing circuit to allow variation in the screen luminance.
(3) In the liquid crystal display device according to the aspect (2), the effective value of the optical data changes γ characteristic of the liquid crystal display device.
(4) The organic EL display device having an organic EL display panel and a video signal processing circuit is provided with a circuit for receiving optical data, and a communication data conversion circuit for inputting the optical data to the video signal processing circuit so as to be converted into an effective value allowed to vary a screen luminance. The effective value is input to the video signal processing circuit to allow variation in the screen luminance.
(5) In the organic EL display device according to the aspect (4), the effective value of the optical data changes a γ characteristic of the organic EL display device.

### BRIEF DESCRIPTION OF THE DRAWINGS

FIG. 1 is a conceptual view showing an example of optical data transmission using a display device;

FIG. 2 is a conceptual view showing an example of optical data reception using the display device;

FIG. 3 is a perspective view of a liquid crystal display panel and a backlight in an assembled state;

FIGS. 4A to 4D are views representing a principle of a first embodiment;

FIG. 5 is a block diagram showing the optical data transmission according to the first embodiment;

FIG. 6 is a block diagram showing the optical data reception according to the first embodiment;

FIGS. 7A to 7D are views representing a principle of a second embodiment;

FIG. 8 is a view showing an example of γ characteristic;

FIG. 9 is a block diagram showing the optical data transmission according to the second embodiment;

FIG. 10 is a block diagram showing the optical data reception according to the second embodiment;

FIG. 11 is a schematic view showing local dimming of the liquid crystal display device having a direct backlight;

FIG. 12 is a schematic view showing the local dimming of the liquid crystal display device having a side backlight;

FIGS. 13A to 13I are schematic views each representing a concept of a third embodiment;

FIG. 14 is a block diagram of an example of the third embodiment; and

FIG. 15 is a block diagram of another example of the third embodiment.

### DETAILED DESCRIPTION OF THE PREFERRED EMBODIMENTS

### Embodiment

The present invention will be described in detail referring to embodiments. In the embodiments, the present invention will be described while taking application of the present invention to the liquid crystal device as an example. However, the present invention may be applied not only to the liquid crystal display device but also the display device provided with the backlight adapted to the optical communication. The present invention may also be applied to the display device provided with no backlight, for example, an organic EL display device.

### First Embodiment

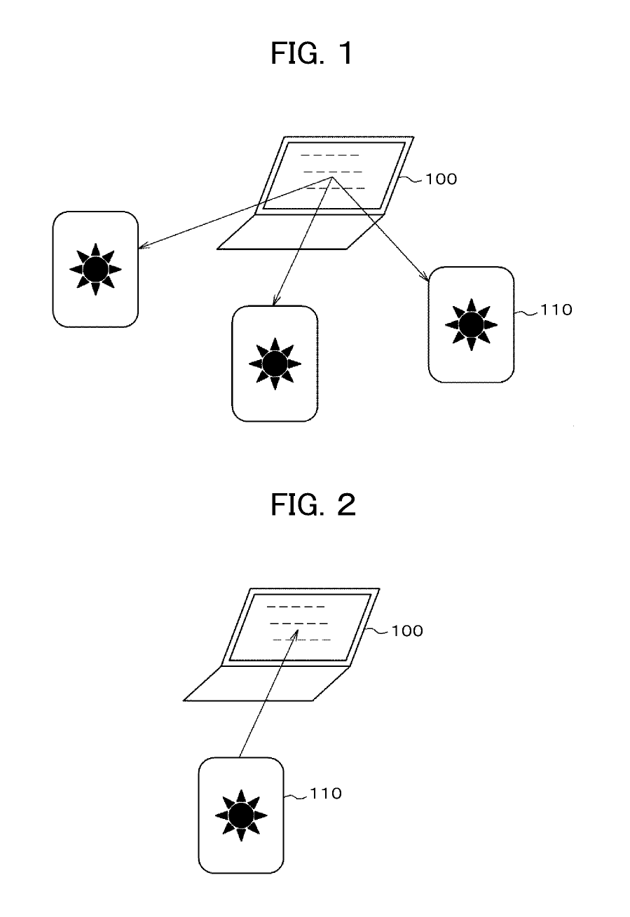

FIG. 1 represents an example to which the present invention is applied. Referring to the drawing, the liquid crystal display device is generally used, while having the weather forecast optically distributed simultaneously. As FIG. 1 shows, the text is displayed on the liquid crystal display device, and the weather forecast data are distributed to a plurality of locations, which are totally different from data displayed on the liquid crystal display device.

FIG. 2 represents another example to which the present invention is applied. Referring to the drawing, the liquid crystal display device is generally used, while optically receiving the weather forecast data which are totally different from the displayed text. The optically received data are stored in the memory, and displayed in need. In other words, the data totally different from those generally derived from wireless or cable data communication are optically received. The optical sensor is built in the liquid crystal display device.

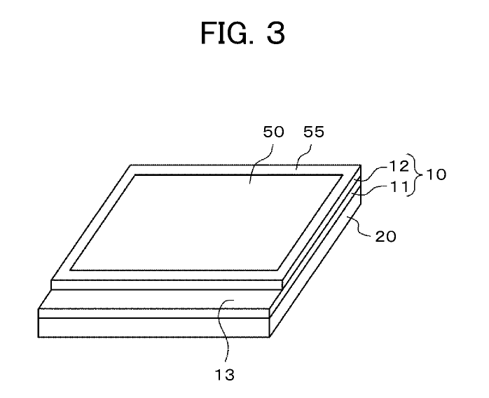

FIG. 3 shows a liquid crystal display panel 10 and a backlight 20, both of which constitute the liquid crystal display device. As the liquid crystal display panel 10 does not emit light by itself, the backlight 20 is disposed on the back surface of the panel so that the image is displayed by the liquid crystal which controls luminous transmittance of a plurality of pixels formed on the display region of the liquid crystal display panel 10. Referring to FIG. 3, the liquid crystal display panel 10 is formed by interposing the liquid crystal between a TFT substrate 11 on which the TFT, the pixel electrode, the video signal line, the scanning line and the like are formed, and a counter substrate 12 on which the black matrix and the like are formed.

As FIG. 3 shows, the part defined by the counter substrate 12 and the TFT substrate 11, which are overlapped with each other constitutes a display region 50. A frame region 55 is formed outside the display region 50. The TFT substrate 11 is made larger than the counter substrate 12 so that the extended part of the TFT substrate 11 constitutes a terminal part 13 on which a drive IC and a terminal are formed. The backlight 20 is disposed on the back surface of the TFT substrate 11. The LED (Light Emitting Diode) is employed for the light source of the backlight.

The LED emits light by the DC current component. The present invention is configured to use light from the backlight for data transmission by superimposing optical communication data on the LED in addition to the DC current for light emission. The data for optical transmission/reception will be referred to as optical data. The optical data may be transmitted from either the display region, or the frame region as shown in FIG. 3. The optical data may also be transmitted from the back surface of the backlight.

Meanwhile, the optical sensor is often disposed on the frame region of the liquid crystal display panel for optical data reception. The optical sensor may be disposed on a part of the display region or the back surface of the backlight. It may also be disposed on the part of the liquid crystal display device except the liquid crystal display panel or the backlight.

The optical data described as shown in FIGS. 1 and 2 are totally different from the data displayed on the liquid crystal display device. The optical data are carried at the frequency far different from that of the current for allowing the LED to emit light. Therefore, the optical data have been regarded as giving no influence on the emission intensity of the LED. Actually, however, the inventor has found out susceptibility of the screen luminance to the optical data contents for transmission/reception. The present invention aims at reducing the influence of the optical data on the screen of the liquid crystal display device.

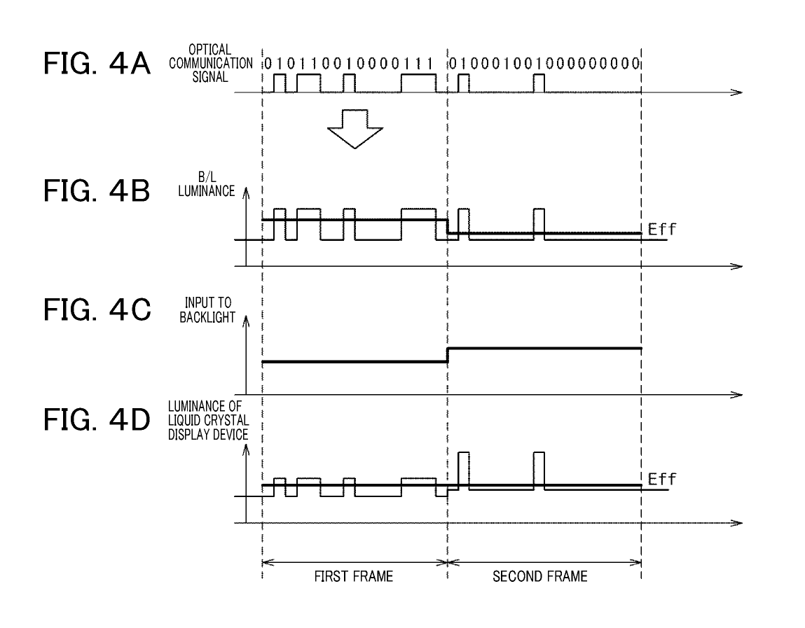

FIGS. 4A to 4D are views representing the principle of the first embodiment according to the present invention. Video data to be displayed on the liquid crystal display device are updated for each frame. The optical data which are different from the video data are transmitted/received irrespective of the video signal. In the present invention, the optical data will be sectioned by a timing for each frame. The sectioned optical data for the respective frames are different from one another. FIG. 4A shows an example of the optical data for transmission or reception. The pulse wave represents the optical data. Referring to FIG. 4A, the optical data amount in the first frame is larger than the optical data amount in the second frame. Actually, the amount of data for transmission/reception for each frame is far larger than the one as shown in FIG. 4A. The drawing indicates the data only for explanatory purpose.

In the first frame, more optical data are transmitted or received than those in the second frame. If the effective value of the optical data is superimposed on the current of the LED employed for the light source of the backlight, the luminance of the LED may vary, thus affecting the image. To be precise, the emission intensity of the LED is determined by the power input to the LED. Therefore, the input current to the LED may be expressed as the input power. FIG. 4A shows an example that the optical data are formed by AM modulation. The present invention may also be applied to the case that the optical data are formed by FM modulation.

FIG. 4B represents that the effective value of the optical data in the first frame is different from that of the optical data in the second frame, which may affect the backlight luminance. In other words, in the first frame, the effective value of the optical data superimposed on the LED power is larger than the one in the second frame, resulting in higher screen luminance in the first frame than the one in the second frame.

FIG. 4C represents that the power to be input to the backlight is changed to neutralize the backlight luminance radiation as shown in FIG. 4B. The power to be input to the backlight may be expressed as the power to be input to the LED as the power source. That is, the effective values of the optical data are calculated for the respective frames so that the power corresponding to the calculated effective value is subtracted from the power input to the LED.

FIG. 4D represents that the luminance of the screen of the liquid crystal display device is kept constant so as to ensure prevention of the image quality deterioration. The pulse shown in FIG. 4D graphically represents that the effective values of the optical signals in the first and the second frames become substantially the same.

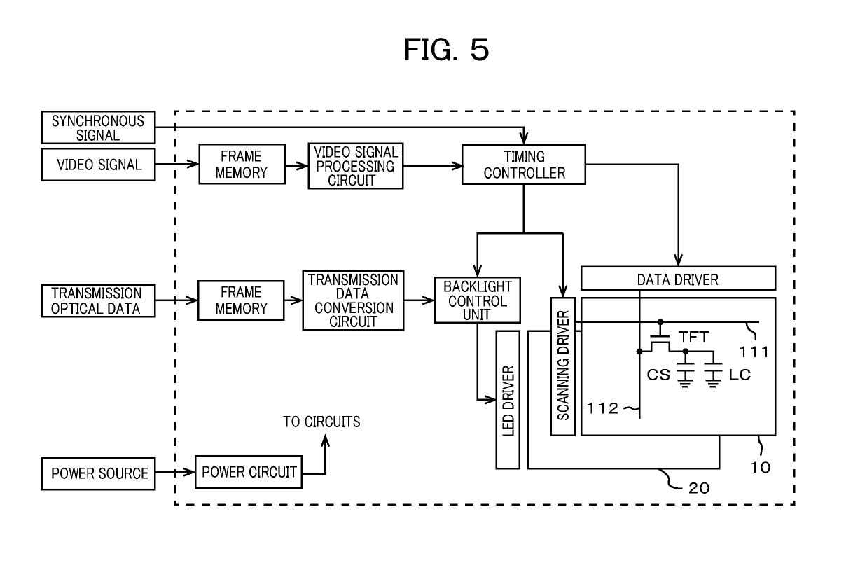

FIG. 5 is a block diagram representing the structure according to the present invention for optical data transmission. Referring to FIG. 5, the synchronous signal is input to a timing controller, and power is supplied to the respective power circuits from the power source. In FIG. 5, the section surrounded by the dashed line is covered by the present invention. Referring to FIG. 5, a video signal is input to the liquid crystal display device wirelessly, or via the cable. The video signal is processed by a video signal processing circuit, and the signal required for displaying the video is supplied to the liquid crystal display panel via a scanning driver, and a data driver from the timing controller. The signal from the timing controller is sent to the LED driver via the backlight control unit.

In the liquid crystal display panel 10, data lines 112 extend in the longitudinal direction, and scanning lines 111 extend in the lateral direction. The pixel is the region defined by the data line 112 and the scanning line 111. Each pixel includes a liquid crystal capacitor LC constituted by the TFT, the pixel electrode and the common electrode, and a storage capacitor CS for retaining the data parallel to the liquid crystal capacitor LC. The backlight 20 is disposed on the back surface of the liquid crystal display panel 10, on which the LED as the light source is disposed.

Referring to FIG. 5, the optical data to be transmitted as those different from the video signal are generated in the liquid crystal display device. In synchronization with capturing of the video signal in the frame, the optical data are captured into the other frame memory. The effective value of the optical data is calculated, and input to the backlight control unit. The backlight control unit captures the power signal into the backlight for displaying the video captured from the timing controller, and the effective value of the optical data from the transmission data conversion circuit. The power for actually driving the LED is calculated, and input to the LED driver.

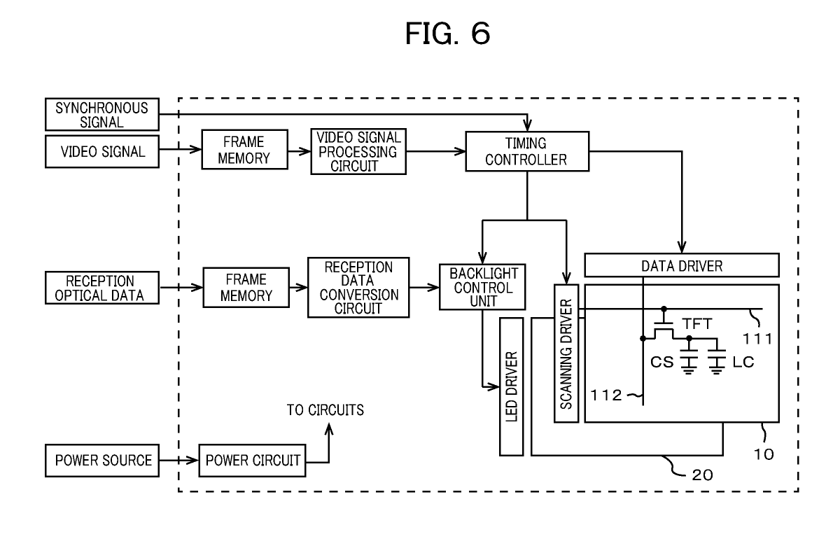

FIG. 6 shows an example that the optical data are input to the liquid crystal display device from the outside. The optical data are totally different from the video signal lines supplied to the liquid crystal display device wirelessly, or via the cable. The optical data from the outside are received by the optical sensor disposed in the liquid crystal display device. The optical data supplied from the outside are captured into the other frame memory in synchronization with capturing of the video signal in the frame. The effective value of the externally captured optical data is calculated, and input to the backlight control unit. The backlight control unit captures the power signal into the backlight for the video display, which has been captured from the timing controller, and the effective value of the optical data from the reception data conversion circuit. The power for actually driving the LED is calculated, and input to the LED driver. Any other structure as shown in FIG. 6 is similar to the one as described referring to FIG. 5.

In the case of transmitting and receiving the optical data, those data are captured into the frame memory in synchronization with capturing of the video signal into the frame, and the effective value of the optical data is calculated so as to be added to the input to the LED driver. This makes it possible to keep luminance of the liquid crystal display device constant. It is therefore possible to suppress deterioration in the image quality caused upon transmission/reception of the optical data which are totally different from the video signal.

### Second Embodiment

This embodiment is configured to suppress the influence of the optical data on the image luminance by changing the transmittance of the liquid crystal display panel instead of neutralizing through the input to the LED of the backlight.

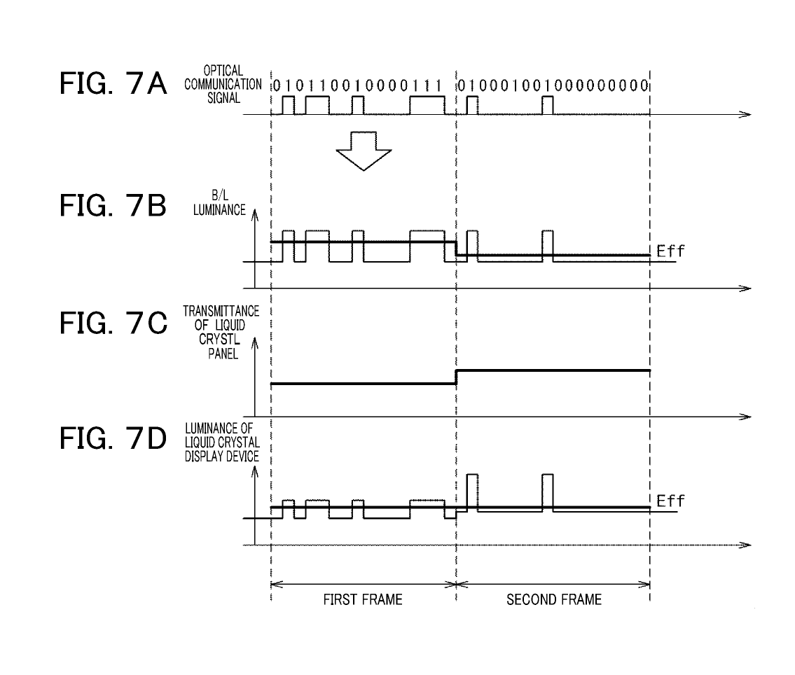

FIGS. 7A to 7D illustrate the principle of the present invention while taking the structure according to the second embodiment as an example. Referring to FIG. 7A, the optical data dissimilar to the video data in the respective frames are different from one another. FIG. 7A shows that the data amount in the first frame is larger than the one in the second frame. Likewise the example as shown in FIG. 4A, more optical data are transmitted or received in the first frame than in the second frame. Likewise the example as shown in FIG. 4B, superimposing of the effective value of the optical data on the current of the LED as the light source of the backlight may vary the LED luminance, thus affecting the image.

FIG. 7B shows that the effective value of the optical data in the first frame is different from that of the optical data in the second frame, which may affect the backlight luminance. In other words, likewise the example as shown in FIG. 4B, as the effective value of the optical data superimposed on the LED power in the first frame is larger than the one in the second frame, the screen luminance in the first frame becomes higher than the one in the second frame.

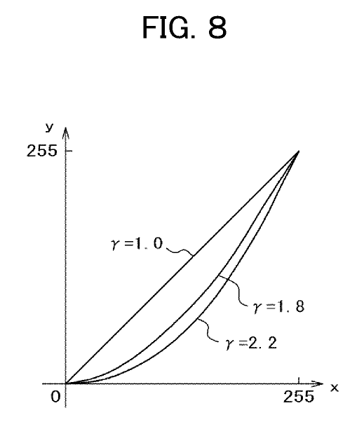

In this embodiment, correction of the effective value of the optical data is not reflected to the backlight control unit for driving the LED, but reflected to the transmittance of the liquid crystal display panel. Specifically, in the embodiment, the property which specifies the relationship between the drive voltage and luminance, that is, γ characteristic may be changed. FIG. 8 shows an example of the γ characteristic while taking a horizontal axis x as the drive voltage, and a vertical axis γ as the luminance. The drawing shows that varying the γ value enables to change the relationship between the drive voltage and the luminance. That is, varying the γ characteristic cannot change the maximum and minimum values of the luminance, but may change the half tone so that the image quality is adjustable.

Referring to FIG. 7C, the transmittance of the liquid crystal display panel varies in accordance with the optical data. In other words, if the optical data amount is small, the γ characteristic may be specified to increase the transmittance of the liquid crystal display panel so as to neutralize the influence of the optical data on the luminance of the liquid crystal display panel as indicated by FIG. 7D.

For example, the required number of tables of the γ characteristic are prepared for implementation of the present invention. Specifically, the effective values of the optical data for transmission/reception are preliminarily classified by several stages, and the γ characteristic tables corresponding to the respective stages are prepared. The calculated effective values of the optical data are assigned to the preliminarily classified effective value ranges in the respective frames. In reference to the γ characteristic table corresponding to each of the effective values, the luminance data of the liquid crystal display panel are obtained.

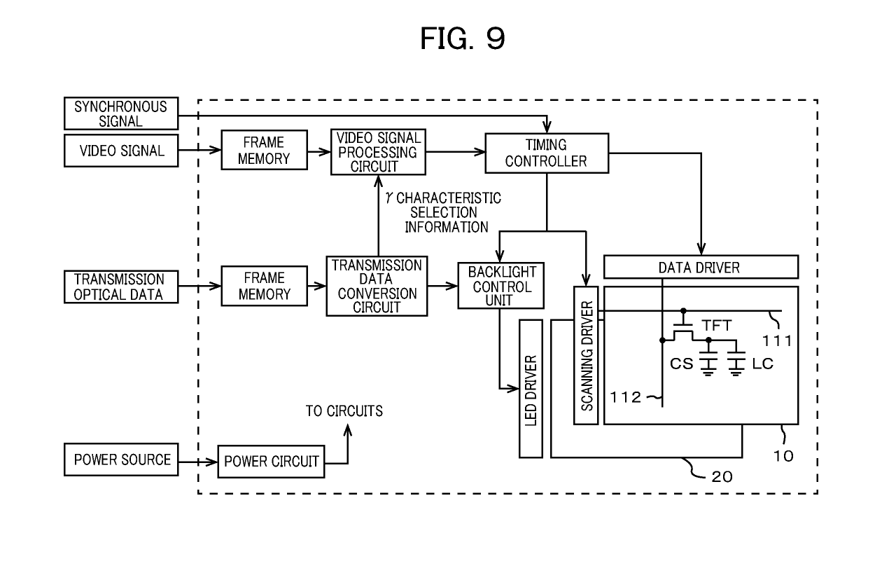

FIG. 9 is a block diagram of the structure to which the embodiment is applied for optical data transmission. Referring to FIG. 9, the basic structure is similar to the one as described referring to FIG. 5. As FIG. 9 shows, the transmission optical data are written into the frame memory corresponding to the frame of the video data. Then the transmission data conversion circuit calculates the effective value of the optical data, which is given to the luminance. The effective value is sent to the video signal processing circuit which selects the γ characteristic table corresponding to the calculated effective value so as to generate the video signal.

The video signal output from the video signal processing circuit has the value derived from adding the effective value of the optical data given to the output signal of the screen luminance. This ensures to reproduce the accurate luminance. Referring to FIG. 9, as the influence of the optical data is input to the video signal processing circuit, the dashed-line arrow for connecting the transmission data conversion circuit and the backlight control unit is not necessarily required. In the case of requiring further accurate luminance control, such connection may be additionally implemented in this embodiment for sending the effective value from the transmission data conversion circuit to the backlight control unit as described in the first embodiment. The rest of the components of the structure is the same as the one described referring to FIG. 5.

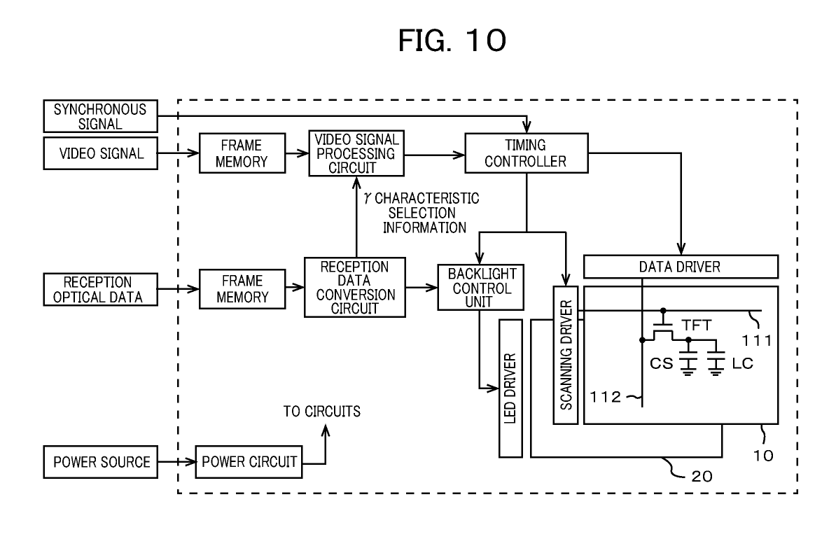

FIG. 10 shows an example that the optical data are input to the liquid crystal display device from the outside. The optical data are totally different from the video signal lines supplied to the liquid crystal display device wirelessly, or via the cable. The external optical data are received by the optical sensor disposed in the liquid crystal display device. Besides the optical data as the reception optical data, the structure shown in FIG. 10 is substantially the same as the one as described referring to FIG. 9.

The embodiment allows the luminance of the liquid crystal display device to be kept constant by capturing the optical data into the frame memory in synchronization with capturing of the video signal into the frame, calculating the effective value of the optical data, and adding the effective value to the γ characteristic of the liquid crystal display panel in the case of either transmission or reception of the optical data. It is possible to suppress the image quality deterioration resulting from transmission/reception of the optical data which are totally different from the video signal.

### Third Embodiment

Power consumed by the backlight accounts for a large portion of the power consumption of the liquid crystal display device. The technology for suppressing the backlight power consumption has been developed, designed to allow the backlight to illuminate only the required part on the screen, while keeping the backlight off so as not to illuminate the dark part on the screen. This technology so called local dimming has been made more practical by using the LED as the light source.

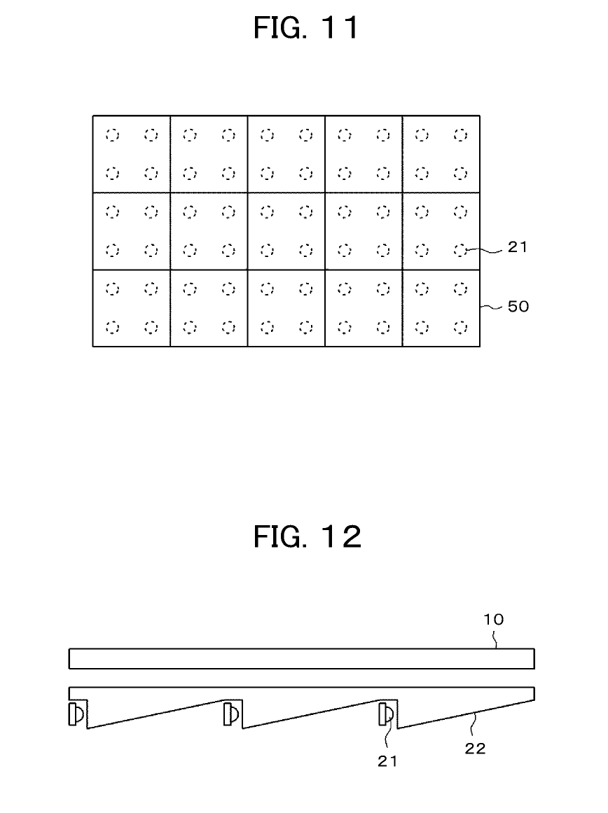

FIG. 11 illustrates a display region 50 of the liquid crystal display panel, which is divided into 15 (5×3) regions, each backlight luminance of which is controlled. In each of the respective regions, four light sources 21, that is, LEDs are disposed. The structure having light from the LED 21 irradiated to the back surface of the liquid crystal display panel is called the direct backlight. The LED 21 corresponding to the region required to be illuminated by the backlight is only turned on so as to suppress power consumption. The LED corresponding to the block of the part unnecessary to be illuminated is not turned on so as to improve the contrast.

FIG. 12 is a sectional view of so called the side backlight configured to have the LED as the light source disposed at the side of a light-guide plate 22, ensuring the local dimming. Specifically, referring to FIG. 12, the light-guide plate 22 is constituted by a plurality of sub-light-guide plates each having the wedge-shaped cross section. The LEDs 21 are disposed for the respective sub-light-guide plates. The sectional view of FIG. 12 shows that each of the sub-light-guide plates has the single LED 21. Actually, however, the plurality of LEDs 21 may be disposed for each of the sub-light-guide plates.

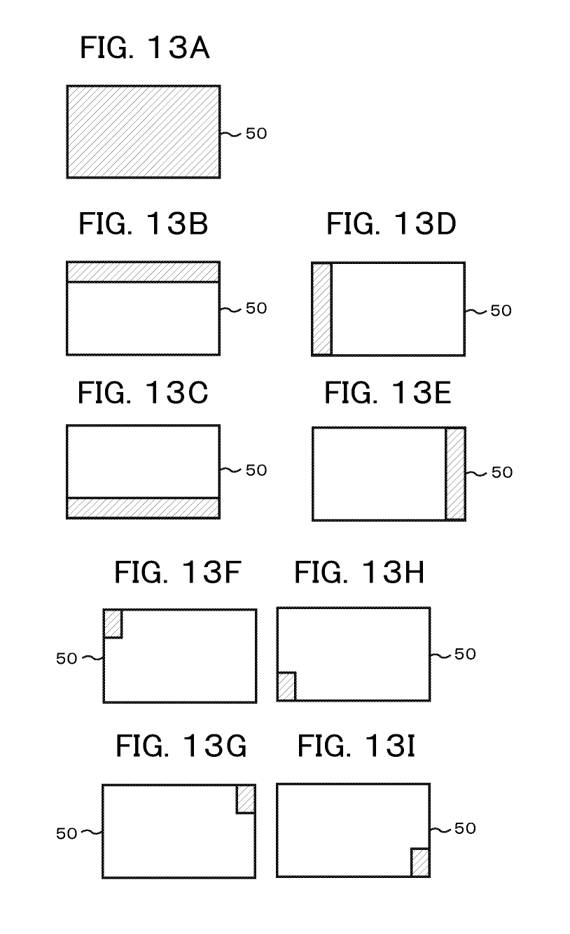

FIGS. 13A to 13I show examples as a result of combining the local dimming with the present invention for optical data transmission. Those drawings show the data transmission performed to the hatched part of the display region 50. FIG. 13A shows the optical data transmission performed to the single entire frame, corresponding to the first or the second embodiment. FIG. 13B shows the optical data transmission for display on the upper longer side of the display region. In this case, the part indicated by FIG. 13B is only affected by the optical data. Therefore, the technology according to the first or the second embodiment may be applied only to the above-described part.

The effective value of the optical data which may affect the luminance is calculated with respect only to the part as shown in FIG. 13B so as to obtain the power input to the LED or the influence on the γ characteristic with respect only to such part. The resultant memory size and calculation amount may be saved, thus reducing the scale of the circuit for implementing the present invention. FIGS. 13C to 13I show various examples of the part for the optical data transmission in the similar manner to the one as described referring to FIG. 13B.

The present invention may be applied not only to the optical data transmission from the display region of the liquid crystal display panel but also to the optical data transmission from the back surface of the liquid crystal display panel, or from the back surface of the liquid crystal display device. Specifically, in the case where the LED light is irradiated from the back surface of the liquid crystal display device, which is superimposed on the optical data for transmission, the local dimming may be utilized to transmit the optical data only to the corresponding part of the display region. This makes it possible to suppress increase in the circuit scale. The region for the optical data transmission from the back surface of the liquid crystal display device may be made the same as each region shown in FIGS. 13A to 13I.

FIGS. 13A to 13I represent examples of the optical data transmission. The embodiment also applies to the optical data reception at the timing as shown in FIGS. 13A to 13I. In this case, the reception timing is sectioned only to the specific time period in the single frame so as to save the memory and calculation amount for the luminance correction.

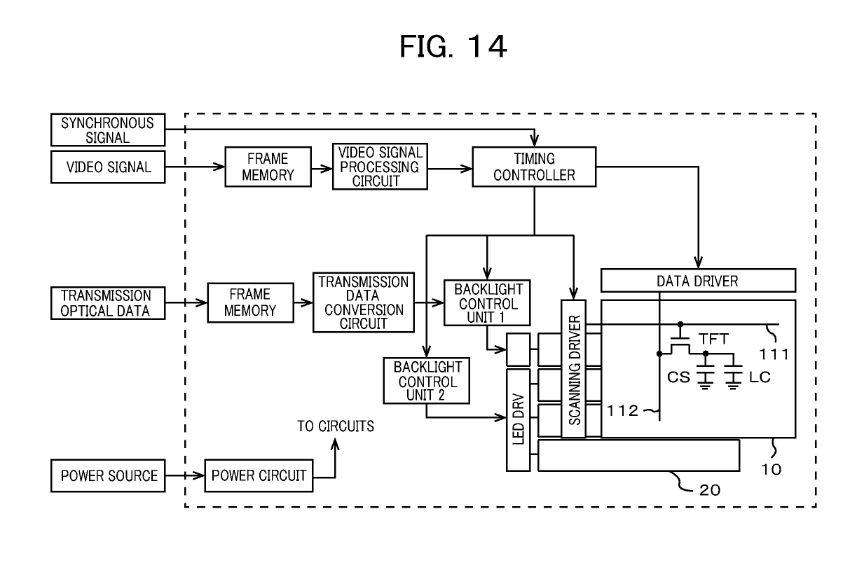

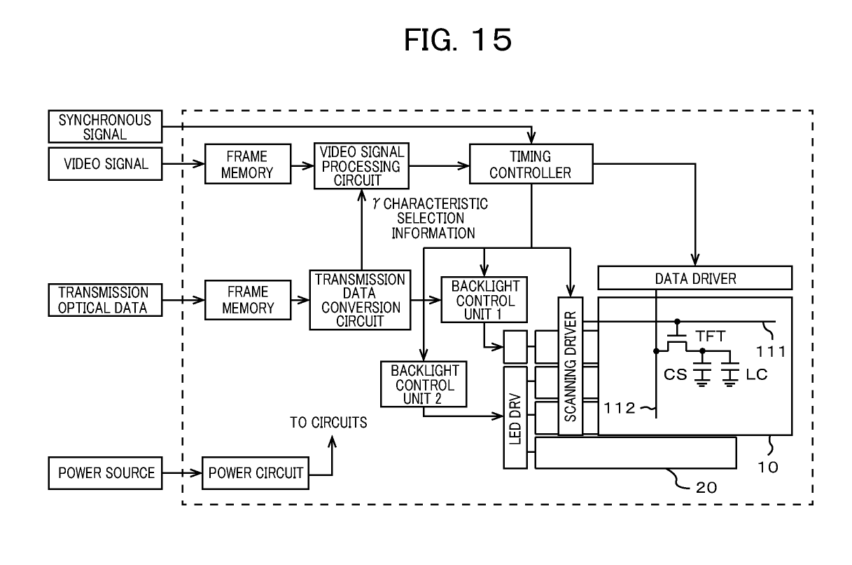

FIG. 14 shows an example of the structure formed by combining the embodiment with the first embodiment. The structure shown in FIG. 14 is different from the one as shown in FIG. 15 in that the optical data are transmitted only when the specific part of the specific display region is displayed. The frame memory which stores the transmission optical data is configured to store the data in the part corresponding only to the specific display region. This makes it possible to reduce the memory size as well as the amount of calculating the effective value performed by the transmission data conversion circuit.

Referring to FIG. 14, the LED driver which controls the backlight LED is formed corresponding to the sectioned part of the display region for local dimming. FIG. 14 shows the optical data transmission only when displaying the part corresponding to the one as shown in FIG. 13B. In this case, data of the effective value calculated by the transmission data conversion circuit are input only to the backlight control unit 1. The aforementioned data are not input to any other backlight control unit. Therefore, the embodiment ensures to reduce the circuit scale for implementing the present invention.

FIG. 15 shows an example of the structure formed by combining the present embodiment with the second embodiment as shown in FIG. 9. The structure shown in FIG. 15 is different from the one shown in FIG. 9 in that the optical data are transmitted only when the specific part of the specific display region is displayed. The frame memory which stores the transmission optical data is configured to store the data in the part corresponding only to the specific display region. This makes it possible to reduce the memory size as well as the amount of calculating the effective value performed by the transmission data conversion circuit.

Referring to FIG. 15, the LED driver which controls the backlight LED is formed corresponding to the sectioned part of the display region for local dimming. FIG. 15 shows the optical data transmission only when displaying the part corresponding to the one as shown in FIG. 13B. In this case, the degree of influence of the effective value of the optical data on the luminance is calculated with respect only to the part corresponding to the one as shown in FIG. 13B. Based on the calculated data, the γ characteristic selection information is sent to the video signal processing circuit.

The video data with corrected γ characteristic are supplied only to the part corresponding to the one as shown in FIG. 13B. In other words, the corrected video data are supplied only to the part corresponding to the backlight control unit 1, thus ensuring to reduce the circuit scale for correction. In this case, data of the effective value calculated by the transmission data conversion circuit are input only to the backlight control unit 1. The aforementioned data are not input to any other backlight control unit. Therefore, the embodiment ensures to reduce the circuit scale for implementing the present invention.

Referring to FIG. 15, as the influence of the optical data is input to the video signal processing circuit, the dashed-line arrow for connecting the transmission data conversion circuit and the backlight control unit is not necessarily required. In the case of requiring further accurate luminance control, the structure shown in FIG. 14 configured to send the effective value from the transmission data conversion circuit to the backlight control unit may be added to the structure as shown in FIG. 15.

This embodiment has been described with respect to the optical data transmission from the liquid crystal display device. However, it may be configured to capture the optical data synchronously with display of a part of the display region. The aforementioned case represents the combination of the present embodiment with the first embodiment as shown in FIG. 6 and the second embodiment as shown in FIG. 10. In this case, the video data upon capturing of the optical data are only affected, which allows correction of only the vide data when the region is displayed. Likewise the optical data transmission, this makes it possible to reduce the circuit scale.

The embodiments have been explained while taking the liquid crystal display device as the example. However, the present invention is applicable to any other display device provided with the backlight.

Upon optical data reception, the optical data may affect the luminance in the case not only of the liquid crystal display device but also the organic EL display device. Therefore, as described in the second or the third embodiment, the structure for correcting the γ characteristic using the effective value of the optical data may be applied to the organic EL display device. Besides the feature having no backlight, the structure according to the second embodiment may be applied.

What is claimed is:

1. A liquid crystal display device including a liquid crystal display panel, a backlight, a video signal processing circuit, and a backlight control unit, comprising:
a circuit for transmitting or receiving optical data; and
a communication data conversion circuit for converting the optical data into an effective value allowed to be superimposed on an input to the backlight, wherein the effective value is input to the backlight control unit so as to allow variation in a luminance of the backlight.

2. The liquid crystal display device according to claim 1, wherein the optical data are transmitted when an image is displayed on a partial region of the liquid crystal display panel.

3. The liquid crystal display device according to claim 1, wherein:
the optical data are written into a frame memory corresponding to a single frame of a video signal; and
the effective value is calculated per the single frame.

4. The liquid crystal display device according to claim 1, wherein an LED is employed for a light source of the backlight.

5. A liquid crystal display device including a liquid crystal display panel, a backlight, a video signal processing circuit, and a backlight control unit, comprising:
a circuit for transmitting or receiving optical data; and
a communication data conversion circuit for inputting the optical data to the video signal processing circuit for conversion into an effective value allowed to vary a screen luminance, wherein the effective value is input to the video signal processing circuit to allow variation in the screen luminance.

6. The liquid crystal display device according to claim 5, wherein the optical data are transmitted or received when an image is displayed on a partial region of the liquid crystal display panel.

7. The liquid crystal display device according to claim 5, wherein the effective value of the optical data changes γ characteristic of the liquid crystal display device.

8. The liquid crystal display device according to claim 5, wherein:
the optical data are written into a frame memory corresponding to a single frame of a video signal; and
the effective value is calculated per the single frame.

9. The liquid crystal display device according to claim 7, comprising a plurality of γ characteristic tables each having a different γ characteristic.

10. The liquid crystal display device according to claim 5, wherein an LED is employed for a light source of the backlight.

11. An organic EL display device including an organic EL display panel and a video signal processing circuit, comprising:
a circuit for receiving optical data; and
a communication data conversion circuit for inputting the optical data to the video signal processing circuit so as to be converted into an effective value allowed to vary a screen luminance, wherein the effective value is input to the video signal processing circuit to allow variation in the screen luminance.

12. The organic EL display device according to claim 11, wherein the optical data are received when an image is displayed on a partial region of the organic EL display panel.

13. The organic EL display device according to claim 11, wherein the effective value of the optical data changes a γ characteristic of the organic EL display device.

14. The organic EL display device according to claim 13 comprising a plurality of γ characteristic tables each having a different γ characteristic.
